(19) United States
(12) Patent Application Publication
(10) Pub. No.: US 2016/0353926 A1
(43) Pub. Date: Dec. 8, 2016

(54) FOOD HOLDER, APPARATUS AND METHOD USING A FOOD HOLDER

(71) Applicant: KONINKLIJKE PHILIPS N.V., EINDHOVEN (NL)

(72) Inventors: YANLING GAO, EINDHOVEN (NL); XINZHONG LAI, EINDHOVEN (NL); WEIMIN XIAO, EINDHOVEN (NL)

(21) Appl. No.: 15/102,580

(22) PCT Filed: Dec. 20, 2014
(86) PCT No.: PCT/EP2014/078937

§ 371 Date: Jun. 8, 2016

(30) Foreign Application Priority Data
Dec. 24, 2013 (CN) PCT/CN2013/090329
Feb. 24, 2014 (EP) 14156299.1

(51) Int. Cl. A47J 37/06; A23L 5/10

(52) U.S. Cl. CPC A47J 37/06; A23L 5/15; A23V 2002/00

(57) ABSTRACT

The present invention relates to a food holder (10) for an apparatus for preparing food by hot air, the food holder comprising: a plurality of first horizontal separation elements (12); a plurality of second horizontal separation elements (14); wherein the first horizontal separation elements (12) and the second horizontal separation elements (14) are arranged in transverse directions (D1, D2) crossing each other; and a plurality of vertical support elements (16) supporting the first horizontal separation elements (12) and the second horizontal separation elements (14); wherein at least one of the group of the first horizontal separation elements (12), the second horizontal separation elements (14), and the vertical support elements (16) are movable in relation to the other elements, in order to form at least one compartment (22) of adjustable size for holding food. It allows adjusting the compartment to the particular size and shape of the food item(s) to be prepared.

### FIELD OF THE INVENTION

The present invention relates in particular to a food holder for an apparatus for preparing food by hot air, to an apparatus for preparing food, and to a method for preparing food.

### BACKGROUND OF THE INVENTION

There are known appliances using hot air for preparing food, including heating and/or cooking food items. The air-based cooking appliances can be used both in the household environment and in food industry. When cooking food by hot air, food ingredients are usually put on a shelf inside a cooking chamber of the appliance. The hot air is circulated inside the cooking chamber during the cooking process. However, putting the food on the shelf is not always convenient for users, as food may have different shapes. Also, placing all food portions on the surface of the shelf is not always possible because the surface is of limited size. Moreover, sometimes the heating is not always uniform due to the stacking of food. As a consequence, food is not evenly cooked.

### SUMMARY OF THE INVENTION

It is an object of the present invention to propose an improved solution for arranging food to be prepared. This object is solved by the subject-matter of the independent claims, wherein further embodiments are incorporated in the dependent claims.

To this end, it is proposed a food holder for an apparatus for preparing food by hot air, the food holder comprising:

a plurality of first horizontal separation elements;

a plurality of second horizontal separation elements;

wherein the first horizontal separation elements and the second horizontal separation elements are arranged in transverse directions crossing each other; and

a plurality of vertical support elements supporting the first horizontal separation elements and the second horizontal separation elements;

wherein at least one of the group of the first horizontal separation elements, the second horizontal separation elements, and the vertical support elements are movable in relation to the other elements, in order to form at least one compartment of adjustable size for holding food.

It allows adjusting the compartment(s) to the particular size and shape of the food item(s) to be prepared. Thereby, it is possible to adjust the size of the compartment to be adapted to the current food's size and shape. For example, food can be arranged in an upright or standing position, thus minimizing a surface contact of the food with the support surface and with other food items. Further, by arranging food in a standing manner, e.g. longitudinally shaped food pieces arranged in a vertical, standing manner, it is possible to provide a stack-pattern still ensuring sufficient space between the individual food pieces. Thereby, a continuous and even distribution of hot air is possible, thus supporting the evenly heating of food from all sides. Hence, the necessity for turning raw food during cooking process is decreased, if not eliminated. Moreover, for a given size of the food preparation chamber, having the possibility of arranging food in a standing manner allows arranging more food items than in the known solutions in the art.

According to a preferred embodiment, a plurality of compartments is provided of adjustable size for holding food.

In an example, a food holder is provided, wherein the compartment can be adjustable in size in at least two different directions, e.g. two transverse horizontal directions. In a further example, a horizontal adjustability in addition to a vertical adjustability is given. In a still further example, two horizontal adjustability directions are provided in addition with vertical adjustment.

In an example, a first horizontal separation element is movable in relation to the second horizontal separation elements and the size of the one or more compartments can thus be adjusted at least in one direction. In a further example, two of the first horizontal separation elements can be moved in relation to the second horizontal separation elements, thus meaning an adjustment of the size in one direction, but on two sides of the compartment. In a further example, in addition to one or two of the first horizontal separation elements, or more or all of the first horizontal separation elements, being movable in relation to the second horizontal separation elements, also the second horizontal separation elements, or at least one of them, or two, or all, can be moved in relation to the other second horizontal separation elements in order to allow an adjustability also in a further direction.

Still further, the first horizontal separation elements and/or second horizontal separation elements can also be moved in relation to the vertical support elements in order to provide adjustment also in the vertical direction for providing compartments with an increased degree of adjustability.

According to a preferred embodiment, the food holder comprises connection elements connecting the first horizontal separation elements and the second horizontal separation elements, the connection elements having a joint enabling a horizontal translation of the first horizontal separation elements and the second horizontal separation elements in relation to each other along a first horizontal translation direction.

This adjustment allows a one-dimensional size adjustment of the compartments, in order to match the size and shape of the food portions.

According to a preferred embodiment, the joint of the connection elements also enables a horizontal translation of the first horizontal separation elements and the second horizontal separation elements in relation to each other along a second horizontal translation direction that is transverse to the first horizontal translation direction. This adjustment allows a two-dimensional size adjustment of the compartments, in order to better match the size and shape of the food portions.

According to a preferred embodiment, the joint of the connection elements also enables a vertical translation of the first horizontal separation elements and the second horizontal separation elements in relation to the vertical support elements along a vertical translation direction. The vertical adjustment allows adapting the height of the compartment to the height of the food portion, for a better holding. Moreover, the vertical adjustment allows to fully utilizing the volume inside the food preparation chamber.

According to a preferred embodiment, at least one of the first horizontal separation elements and the second horizontal separation elements are provided as straight bar members.

Using straight bar members is a convenient and cost-effective solution.

According to a preferred embodiment, at least one of the first horizontal separation elements and the second horizontal separation elements are provided as undulated bar members.

This facilitates the food to be positioned vertically or inclined.

According to a preferred embodiment, the first horizontal separation elements and the second horizontal separation elements are forming different horizontal layers stacked vertically.

Different layers allow a better holding of the food portions in the compartments.

According to a preferred embodiment, the connection elements comprise a resilient bearing element providing a predetermined clamping force on the element that is movably hold by the connection element.

The clamping force relates to a force acting on the bar members, or bar elements, such that manual movement requires the application of a certain force by user, but a separation fixation is not required to hold the bars/members in place for properly holding the food during the preparation by hot air. The clamping force results in a defined movability with respect to the manual activation during the translation of the members/elements.

According to a preferred embodiment, the connection elements are provided as knot structures that are translatable along at least the elements of one of the first horizontal separation elements and the second horizontal separation elements.

The knot structure is a convenient solution to connect different separation elements.

According to a preferred embodiment, the vertical support elements are reversed-T-shaped.

This ensures stability for the food holder.

The invention also relates to an apparatus for preparing food, the apparatus comprising:

a food preparation chamber with a bottom support;

a system to generate a flow of hot air; and

a food holder according to one of the preceding claims; and

wherein the food holder is placed inside the food preparation chamber on the bottom support.

The adjustable food holder assists the uniform distribution of heating energy or thermal conduction within air-based kitchen appliances such as fryers, ovens etc. The adjustable food holder is located in the cooking chamber, and food items can be arranged, for example, vertically, or inclined at an angle on the shelf. Thus, the space of the whole cooking chamber can be used efficiently, and the distribution of thermal energy is uniform with minimum blockage by food. The food holder can be adjusted to fit different sizes and shapes of foods. The user's comfort is increased, since it is more convenient, because food can be cooked evenly without the need to turn the food over during the cooking process. Further, food will also stick less to the food holder, due to the even heating and less direct contacting area than with the food holders known in the art.

The adjustability is provided by connecting a number of separation elements in a way that they can be moved with respect to each other, for example by translation. For example, the connection elements are provided in such a way that a translation movement along an axis of one of the separation elements is possible. The adjustable food holder thus provides grid cells that can fit in different cooking devices. The grid cells on the shelf are adjustable in order to match different sizes of (raw) food.

Raw food can stand inside the adjustable compartment(s), and thus the cooking chamber space can be utilized to an increased degree, and the food to be prepared does not block the distribution of thermal conduction, or the circulation of hot air. Further, since the adjustable food holder is composed of bars and has thus an open structure, the thermal conduction from infrared radiation, or circulated hot air will not be blocked, and the heating inside is uniform.

According to a preferred embodiment, the bottom support comprises a plurality of openings.

This allows hot air circulating from below the food arranged in the food holder.

According to a preferred embodiment, the apparatus further comprises air guiding means to guide hot air to the bottom support from below.

This further improves circulation of hot air around food arranged in the food holder.

The invention also relates to a method for preparing food by using a food holder according to the invention, in order to form compartments of adjustable size for holding food portions.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 shows a food holder according to the invention;

FIG. 2A shows a food holder according to the invention;

FIG. 2B shows a food holder according to the invention;

FIG. 3 shows a food holder according to the invention;

FIG. 4 shows a food holder according to the invention;

FIG. 5 shows a food holder according to the invention;

FIG. 6 shows a food holder according to the invention;

FIG. 7A shows a detailed view of a connection element in a food holder according to the invention;

FIG. 7B shows a detailed view of a connection element in a food holder according to the invention;

FIG. 8 shows an apparatus using a food holder according to the invention;

FIG. 9A shows an apparatus using a food holder according to the invention;

FIG. 9B shows a detailed view of an apparatus using a food holder according to the invention;

FIG. 10 shows a flow chart of a method according to the invention.

### DETAILED DESCRIPTION OF EMBODIMENTS

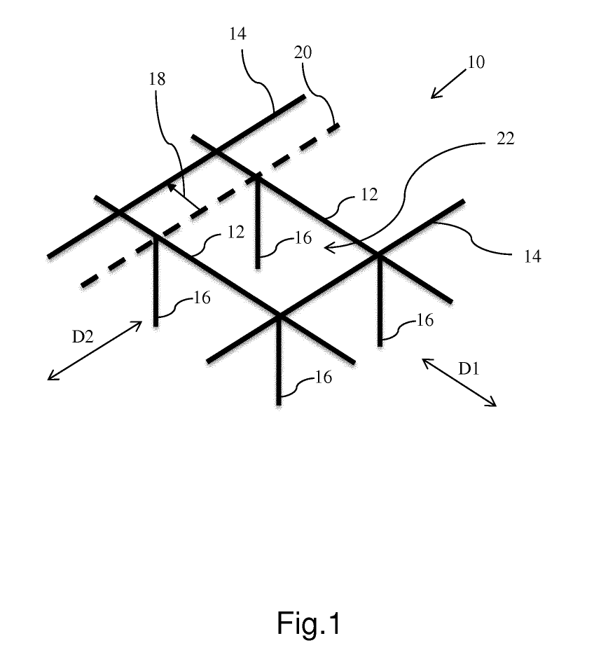

FIG. 1 shows a food holder 10 for an apparatus for heating food by hot air. The food holder 10 comprises a plurality of first horizontal separation elements 12, and a plurality of second horizontal separation elements 14. The first horizontal separation elements 12 and second horizontal separation elements 14 are arranged in transverse directions crossing each other. For example, the first horizontal separation elements are aligned to a first direction D1, and the second horizontal separation elements 14 are arranged aligned with a second direction D2. Further, a plurality of vertical support elements 16 is provided, supporting the first horizontal separation elements 12 and second horizontal separation elements 14. At least one of the groups of the first horizontal separation elements 12, the second horizontal separation elements 14, and the vertical support elements 16 are movable in relation to the other elements, as indicated with movement arrow 18 with respect to the movability of an element, for example, of the second horizontal separation elements 14. A hashed line 20 indicates the previous location of the particular separation element. Hence, it is possible to adjust compartments 22 for holding food, or in other words, the movability is provided in order to form at least one compartment of adjustable size for holding the food.

It is noted that FIG. 1 shows the concept in a schematic way and a different number of the respective first horizontal separation elements 12 or second horizontal separation elements 14, or vertical separation elements 16, is provided for arranging, for example, a plurality of the compartments 22.

The first horizontal separation elements 12, second horizontal separation elements 14 and support elements 16 form a three-dimensional holding structure and provide the adjustable compartments for receiving food portions.

The term “horizontal” relates to the orientation in normal use. The horizontal separation elements are provided aligned, i.e. parallel to the horizontal direction, or inclined (not shown) with an angle of maximum 45°, for example 45°, 30°, 20°, 15°, 10°, 5° or less.

The term “vertical” relates to the orientation in normal use. The vertical support elements are provided aligned, i.e. parallel to the vertical direction, or inclined (not shown) with an angle of maximum 45°, for example 45°, 30°, 20°, 15°, 10°, 5° or less.

Preferably, the term “transverse” relates to an angle of 90°, but also angles around an angle of 90°, such as 90°+/−5°, or 90°+/−10°.

Alternatively, the term “transverse” relates angles having various values, such as, for example, 15°, 30°, 45°, 60° or more generally any angle values within the range of 15° to 90°.

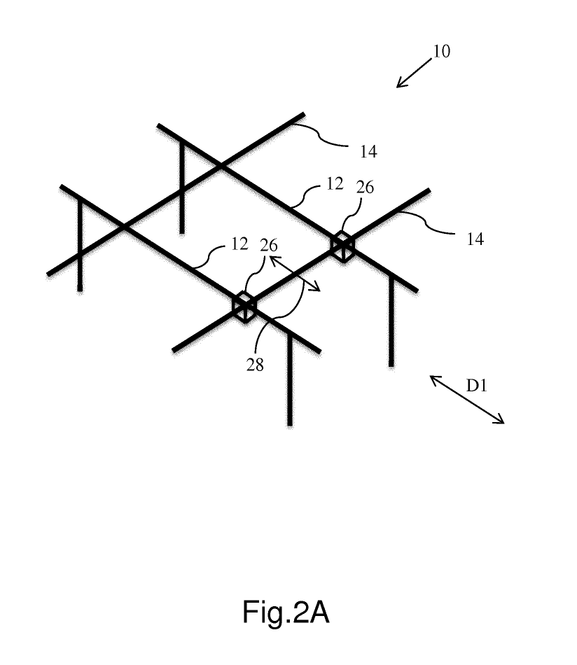

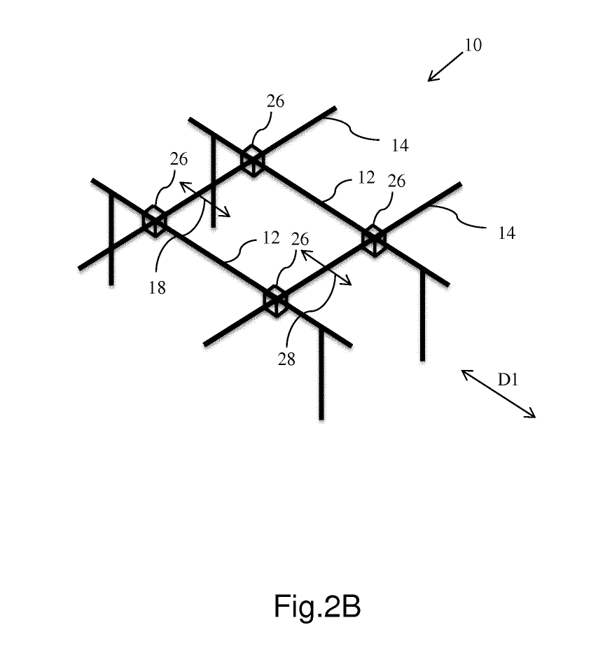

FIG. 2A shows a food holder 10 according to the invention. Connection elements 26 are provided, connecting the first horizontal separation elements 12 and the second horizontal separation elements 14. The connection elements 26 have a joint enabling a horizontal translation of the first horizontal separation elements 12 and the second horizontal separation elements 14 in relation to each other along a first horizontal translation direction D1. The connection elements 26 are also referred to as connecting knots. For example, the connection elements 26 enable a horizontal translation 28 of one of the second horizontal separation element 14 along a first horizontal translation direction D1. For example, as illustrated in FIG. 2B, the connection elements 26 enable a horizontal translation 28 of one of the second horizontal separation element 14 along a first horizontal translation direction D1, and a horizontal translation 18 of another second horizontal separation element 14 along the first horizontal translation direction D1.

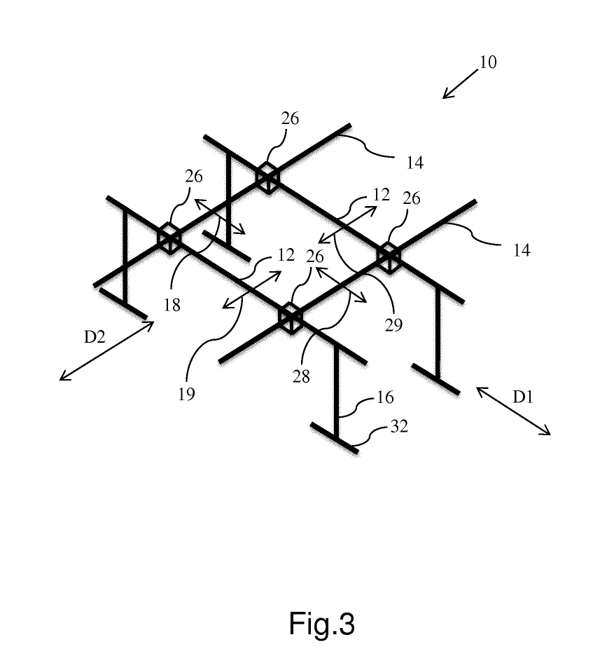

FIG. 3 shows an example, where the joint of the connection elements 26 also enables a horizontal translation of the first horizontal separation elements 12 and the second horizontal separation elements 14 in relation to each other in a second horizontal translation direction D2. The second horizontal translation direction D2 is transverse to the first horizontal translation direction D1.

For example, as illustrated in FIG. 3, and compared to the device of FIG. 2B, the connection elements 26 further enable a horizontal translation 29 of one of the first horizontal separation element 12 along the second horizontal translation direction D2, and a horizontal translation 19 of another first horizontal separation element 12 along the second horizontal translation direction D2.

In FIG. 3, it is shown that all of the horizontal separation elements can be moved and are adjustable. However, it is also possible to provide a part of the horizontal separation elements to be fixed and another part to be movable.

Preferably, the vertical support elements 16 are shaped as a reversed T, as indicated with reference numeral 32.

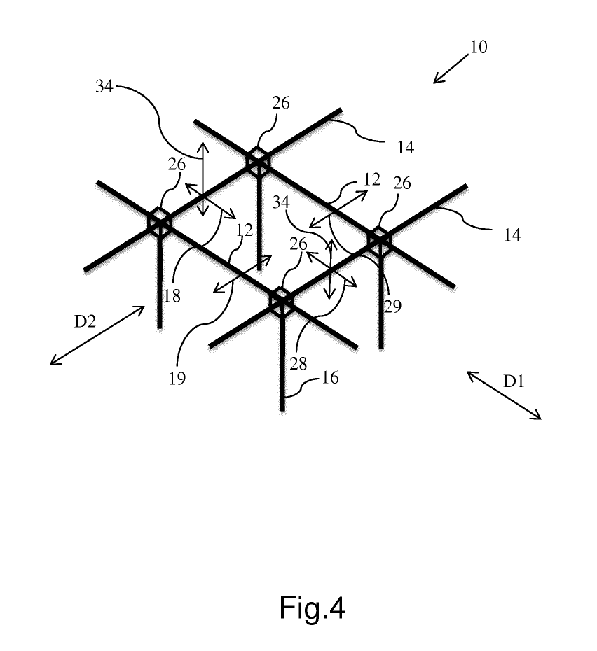

FIG. 4 shows a preferred embodiment, where the joint of the connection elements 26 also enable a vertical translation 34 of the first horizontal separation elements 12 and the second horizontal separation elements 14 in relation to the vertical support elements 16 in a vertical translation direction D3.

In a preferred embodiment, for the relative movement, the connection elements 26 are manually movable along and in relation to the elements of at least one of the group of the first horizontal separation elements 12, the second horizontal separation elements 14, and the vertical support elements 16.

The various separation elements 12, 14, 16 are made of heat resistant material, for example stainless steel.

In a preferred embodiment (not shown), the connection elements 26 are movable horizontally along the first horizontal separation elements 12, or along the second horizontal separation elements 14, and are fixed in relation to the other of the first horizontal separation elements 12 and the second horizontal separation elements 14.

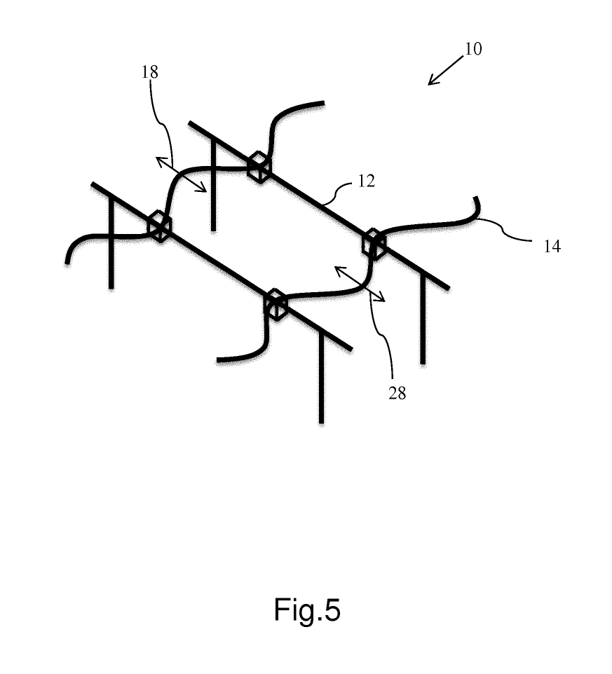

In a preferred embodiment, at least one of the first horizontal separation elements 12 and the second horizontal separation elements 14 are provided as straight bar members. Such embodiment is for example illustrated by FIG. 5, in which the first horizontal separation elements 12 are provided as straight bar members, or by FIG. 2A where both the first horizontal separation elements and the second horizontal separation elements are provided as straight bar members.

In a preferred embodiment, at least one of the first horizontal separation elements 12 and the second horizontal separation elements 14 are provided as undulated bar members. Such embodiment is for example illustrated by FIG. 5, in which the second horizontal separation elements 14 are provided as the undulated bar members. For example, the undulated bar members have a wave form which is arranged in a horizontal wave pattern.

In a further preferred embodiment (not shown), both the first horizontal separation elements 12 and the second horizontal separation elements 14 are provided as undulated bar members.

In a preferred embodiment, the first horizontal separation elements 12 or the second horizontal separation elements 14 are provided as straight bar members; and the other of the first horizontal separation elements and the second horizontal separation elements are provided as undulated bar members, as indicated in FIG. 5.

In a preferred embodiment, the connection elements are fixedly arranged with respect to the undulated bar members, and movable along the straight bar members.

In a preferred embodiment, the connection elements are arranged movable with respect to both the undulated bar members and the straight bar members.

In a preferred embodiment, the first horizontal separation elements 12 and the second horizontal separation elements 14 are provided as undulated bar members.

In a preferred embodiment, the elements of the first horizontal separation elements 12 and the second horizontal separation elements 14 are provided as straight bar members.

The vertical support elements 16 are provided preferably as vertical straight bar members, as shown in FIG. 5. In another example (not shown), the vertical support elements are provided as vertical undulated bar members. The provision of undulated bar members provides an increased variety of possible sizes that can be adjusted with the adjustable compartments.

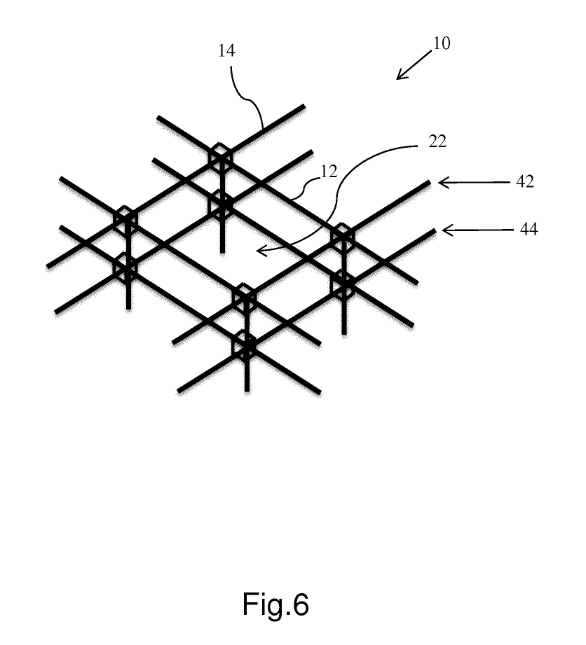

FIG. 6 shows an example where the first horizontal separation elements 12 and the second horizontal separation elements 14 are forming different horizontal layers 42, 44, that are stacked vertically.

In a preferred embodiment, the first horizontal separation elements 12 and the second horizontal separation elements 14 are provided as at least two parallel elements having at least a lower member (in layer 44) and an upper member (in layer 42). More generally, a plurality of members can be arranged successively in vertical direction.

It is noted that FIG. 6 shows the horizontal separation elements as straight bar members. However, in a further example, the horizontal separation elements are at least partly provided as undulated bar members.

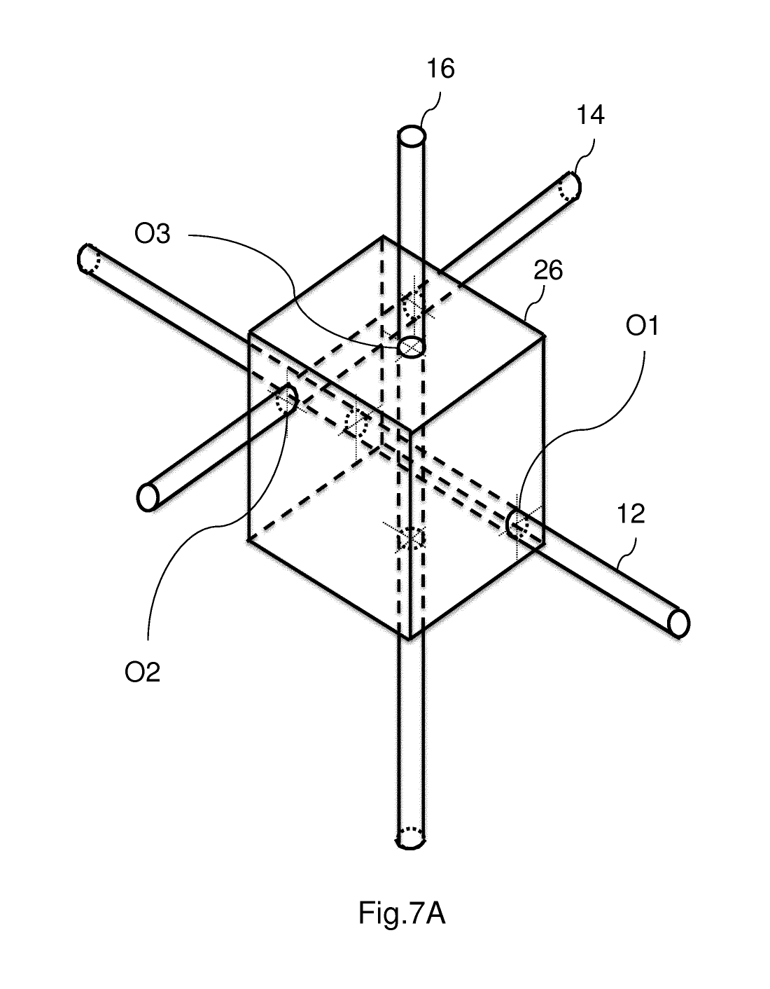

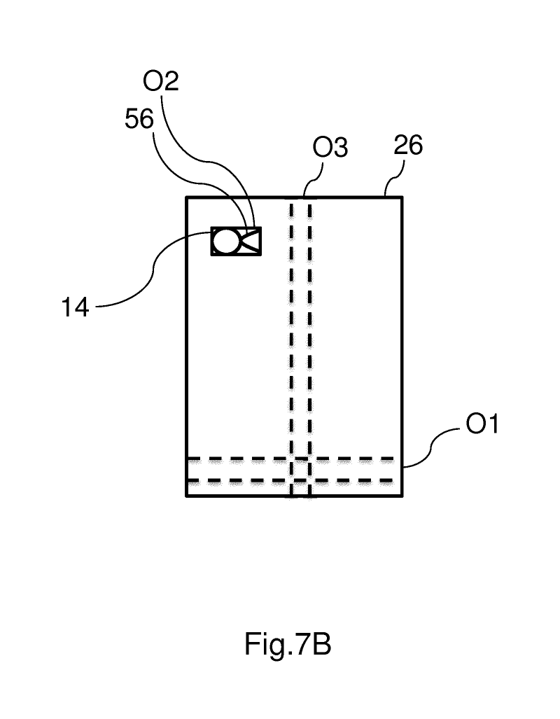

FIG. 7A shows in a three-dimensional view, a preferred embodiment of the connection element 26. The connection elements 26 are for example made of a plain material, such as aluminium, in which three through-openings O1, O2, O3 are made. The through-opening O1 allows displacement of the first horizontal separation elements 12, the through-opening O2 allows displacement of the second horizontal separation elements 14, the through-opening O3 allows displacement of the vertical support elements 16. The through-openings O1, O2, O3 have a diameter same as the diameter of the elements 12, 14, 16, respectively, so that a light resistance is exerted on the elements 12, 14, 16 by the internal walls of the through-openings O1, O2, O3, during their movement relative to each other via the connection element 26.

FIG. 7B shows in a two-dimensional view, a preferred embodiment of a connection element 26. The connection element 26 has an enlarged recess O2 for fixing a bar element, for example an element of the second horizontal separation elements 14. The connection element 26 has at least one resilient bearing element 56, providing a predetermined clamping force on the element that is movably held by the connection element 26, i.e. a clamping force is acting on the second horizontal separation element 14. Thus, it is possible to adjust and compensate for different bar diameters, for example caused by fat from food ingredients that would have stuck to the bar element. This type of clamping is also preferred when undulated bars are used.

The term “resilient” relates to a bearing surface being capable to adjust for variations in the diameter of the separation element held by the connection knot such that a sliding movement is possible with same or at least similar pushing force necessary for manually activating the sliding movement for adjusting the compartment's form and/or size, while the bearing surface exerting a given force on the separation element to keep this separation element in place after it was moved.

The at least one resilient bearing element may be provided as a bearing contact that is biased by a spring element. In another example, the bearing element comprises a resilient surface cover.

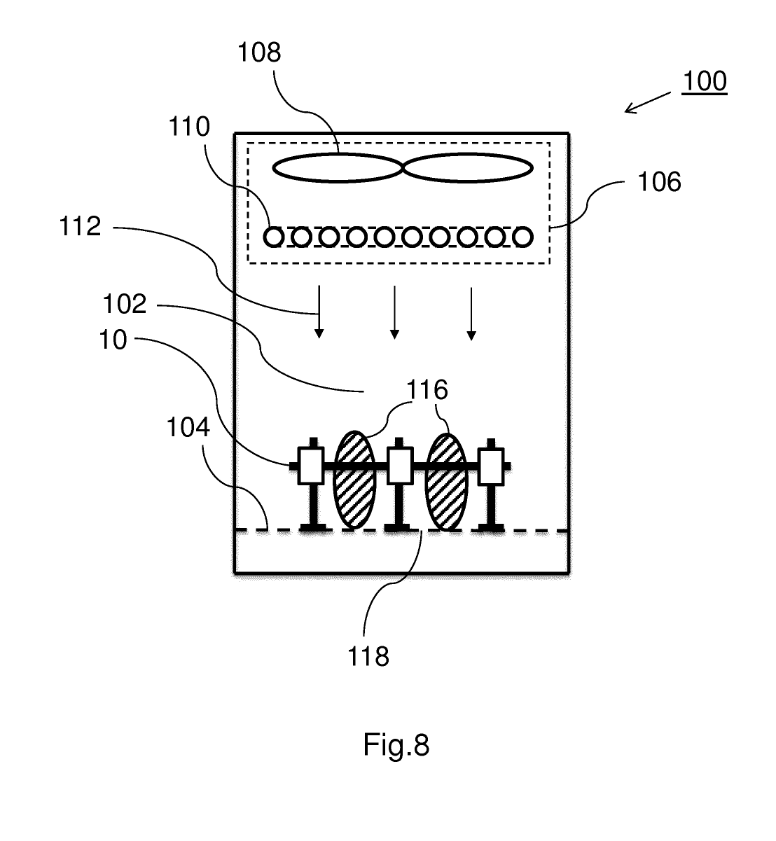

FIG. 8 shows a first type of apparatus 100 for preparing food according to the invention. The apparatus 100 comprises a food preparation chamber 102 with a bottom support 104. Further, a system 106 to generate a flow of hot air is provided, which for example comprises a fan 108 and a heater 110. The heater may correspond, for example, to a resistive heating element, or a halogen lamp. The generated flow of hot air is indicated with a plurality of flow arrows 112. Further, a food holder 10 according to one of the above-mentioned examples is provided. The food holder 10 is placed inside the food preparation chamber 102 on the bottom support 104. Access to the inside part of the food preparation chamber 102 and the food holder 10 is for example done via a drawer mechanism that opens on a lateral side of the apparatus (not shown). The apparatus 100 is an apparatus that is suitable for household purposes. With such type of apparatus, the air flow is provided with a high velocity and high flow rate in the food preparation chamber, for example with an air flow rate of approximately minimum 20 l/s. The term “hot air” relates to an air temperature with a range of approximately 80° C. to 250° C.

Preferably, the bottom support 104 is provided with a plurality of openings, indicated by a dashed line 118, so that hot air can circulate all around the food portions 116 disposed in the compartments of the food holder 10.

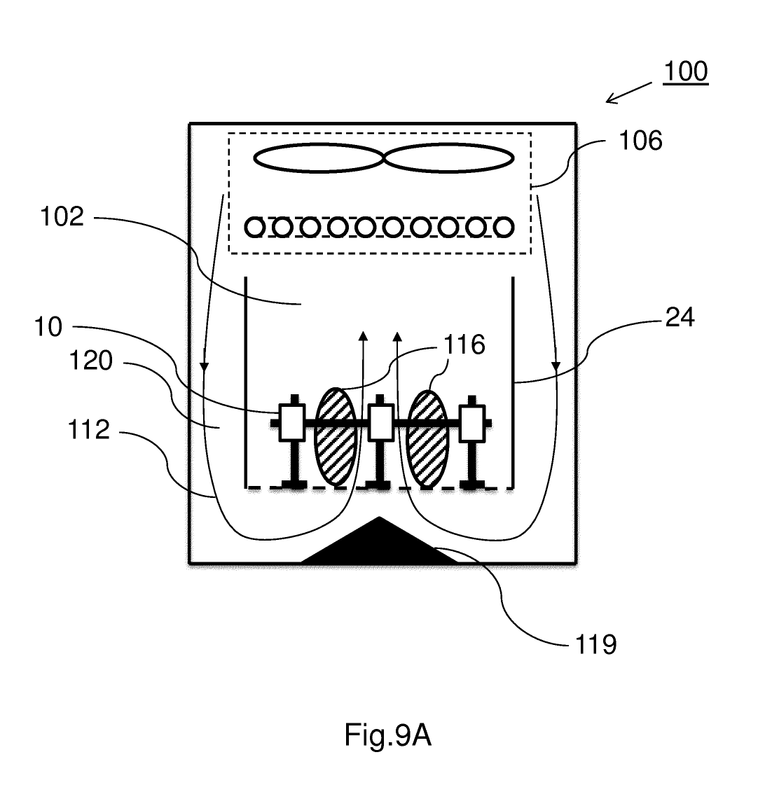

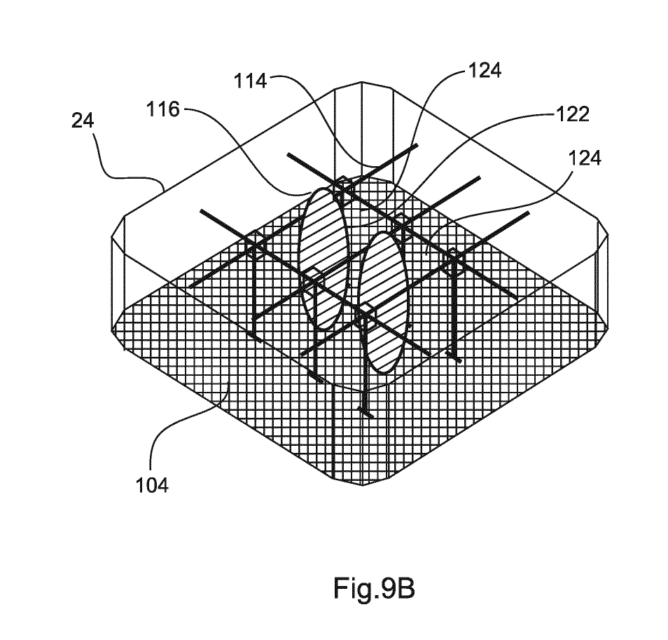

FIG. 9A shows a second type of apparatus 100 for preparing food according to the invention. In addition to the apparatus described in FIG. 8, the apparatus 100 comprises air guide means 120. The air guide means 120 are provided to guide hot air to the bottom support from below, as illustrated with flow arrows 112. For example, the air guide means 120 are formed by the space between the external walls of apparatus and internal wall of a food basket 24 in which the food holder is placed. An air guide member 119 may optionally be placed below the bottom support 104 so that hot air evenly flows on food portions 116 from below. FIG. 9B shows a detailed view of the food holder 10 on an air-permeable meshed bottom support 104, placed inside the food basket 24.

A further aspect is also shown in relation with FIG. 9B. As can be seen, a plurality of compartments is provided for holding food. For example, two oval shaped structures 122 are indicated, each inside a separate compartment, the compartments being referred to with reference number 124. As an option, middle compartments can be surrounded by separation elements on all circumferential sides. Further, portions adjacent to the edge of the container may be provided by separation elements on only two sides (corner segments) or three sides (side portions). In a further option, not shown, also a circumferential separation element line is provided. It must be noted that the aspect of a plurality of compartments, i.e. two, three, four or more compartments, such as five, six, seven, eight, nine ten or more that ten compartments is an aspect that can be combined with any of the other features described above and below.

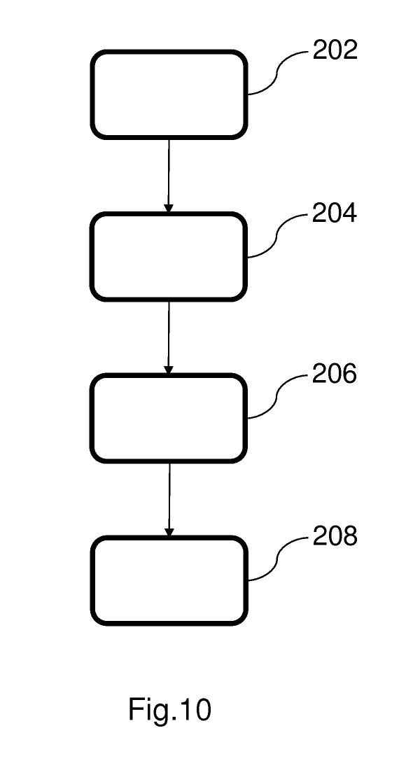

FIG. 10 shows a flow chart of a method according to the invention. The method comprises the steps of:
adjusting 202 the size of at least one adjustable compartment of a food holder comprising:
   a plurality of first horizontal separation elements
   a plurality of second horizontal separation elements; wherein the first horizontal separation elements and second horizontal separation elements are arranged in transverse directions crossing each other; and
   a plurality of vertical support elements supporting the first horizontal separation elements and second horizontal separation elements; wherein the elements of at least one of the group of the first horizontal separation elements, the second horizontal separation elements, and the vertical support elements are movable in relation to the other elements, in order to form at least one compartment of adjustable size for holding food;
arranging 204 the food holder in an apparatus for preparing food comprising at least a system to generate a flow of hot air and a food preparation chamber having a bottom support; wherein the food holder is placed inside the food preparation chamber on the bottom support;
arranging 206 food portions in the at least one compartment; and
flowing 208 the hot air in the food preparation chamber, for preparing the food by heating.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A food holder for an apparatus for preparing food by hot air, the food holder comprising:
a plurality of first horizontal separation elements;
a plurality of second horizontal separation elements;
wherein the first horizontal separation elements and the second horizontal separation elements are arranged in transverse directions crossing each other; and
a plurality of vertical support elements supporting the first horizontal separation elements and the second horizontal separation elements;
wherein first horizontal separation elements and the second horizontal separation elements are movable in relation to each other, in order to form at least one compartment of adjustable size for holding food, and
connection elements connecting the first horizontal separation and the second horizontal separation elements, the connection elements having a joint enabling a horizontal translation of the first horizontal separation elements and the second horizontal separation elements in relation to each other along a first horizontal translation direction.

2. Food holder according to claim 1, wherein a plurality of compartments is provided of adjustable size for holding food.

3. (canceled)

4. Food holder according to claim 2, wherein the joint of the connection elements also enables a horizontal translation of the first horizontal separation elements and the second horizontal separation elements in relation to each other along a second horizontal translation direction that is transverse to the first horizontal translation direction.

5. Food holder according to claim 4, wherein the joint of the connection elements also enables a vertical translation of the first horizontal separation elements and the second horizontal separation elements in relation to the vertical support elements along a vertical translation direction.

6. Food holder according to claim 1, wherein at least one of the first horizontal separation elements and the second horizontal separation elements are provided as straight bar members.

7. Food holder according to claim 1, wherein at least one of the first horizontal separation elements and the second horizontal separation elements are provided as undulated bar members.

8. Food holder according to claim 1, wherein the first horizontal separation elements and the second horizontal separation elements are forming different horizontal layers stacked vertically.

9. Food holder according to claim 8, wherein the connection elements comprise a resilient bearing element providing a predetermined clamping force on the element that is movably hold by the connection element.

10. Food holder according to claim 9, wherein the connection elements are provided as knot structures that are translatable along at least the elements of one of the first horizontal separation elements and the second horizontal separation elements.

11. Food holder according to claim 1, wherein the vertical support elements are reversed-T-shaped.

12. An apparatus for preparing food, the apparatus comprising:
a food preparation chamber with a bottom support;
a system to generate a flow of hot air; and
a food holder according to claim 1; and
wherein the food holder is placed inside the food preparation chamber on the bottom support.

13. Apparatus according to claim 12, wherein the bottom support comprises a plurality of openings.

14. Apparatus according to claim 12, further comprising air guiding means to guide hot air to the bottom support from below.

15. A method for preparing food, comprising the following steps:
a) adjusting the size of at least one adjustable compartment of a food holder according to claim 1,
b) arranging the food holder in an apparatus for preparing food comprising at least a system to generate a flow of hot air and a food preparation chamber having a bottom support; wherein the food holder is placed inside the food preparation chamber on the bottom support;
c) arranging food portions in the at least one compartment; and
d) flowing the hot air in the food preparation chamber, for preparing the food by heating.
